(19) United States
(12) Patent Application Publication
(10) Pub. No.: US 2005/0130512 A1
(43) Pub. Date: Jun. 16, 2005

(54) Terminal structure of a ZIF electrical connector

(76) Inventor: Chou Hsuan Tsai, Hsin-Chuang City (TW)

Correspondence Address: PRO-TECTOR INTERNATIONAL SERVICES, 20775 NORADA CT., SARATOGA, CA, 95070, US

(21) Appl. No.: 11/004,015

(22) Filed: Dec. 2, 2004

(30) Foreign Application Priority Data
Dec. 12, 2003 (TW) 092221888

(51) Int. Cl. H01R 11/22

(52) U.S. Cl. 439/875

(57) ABSTRACT

A terminal structure of a ZIF (Zero Insertion Force) electrical connector includes a U-shaped main body, two first plates and two second plates. The U-shaped main body has two side plate surfaces facing each other with a gap formed therebetween. The first plates are disposed at a top front section of the U-shaped main body and face each other with a first gap formed therebetween. The second plates are disposed at a top rear section of the U-shaped main body and face each other with a second gap formed therebetween, and the second gap is smaller than the first gap.

### BACKGROUND OF THE INVENTION

1. Field of the Invention

The invention relates to an electrical connector, and more particularly to a terminal structure of a ZIF (Zero Insertion Force) electrical connector.

2. Description of the Related Art

A center processing unit (CPU) has many pins to be connected to a ZIF (Zero Insertion Force) electrical connector, which is disclosed in Taiwan Patent Publication Nos. 269919 (U.S. Pat. No. 5,616,044), 240866 and 271866.

FIG. 1 is a pictorially exploded view showing a conventional ZIF electrical connector. Referring to FIG. 1, the ZIF electrical connector has a plastic base 10 and several terminals 15. The plastic base 10 is formed with a plurality of terminal slots 11. The terminal 15 has a fixing portion 16, a pin 17, an elastic arm 18 and a contact sheet 19. The fixing portion 16 may be fixed to the terminal slot 11. The pin 17 is connected to the fixing portion 16 and extends downwards. The elastic arm 18 is connected to the fixing portion 16, and the contact sheet 19 is connected to a top of the elastic arm 18. The contact sheet 19 has a two-step shape such that the contact sheet 19 and the terminal slot 11 form a wide region 12 and a narrow region 13 when the terminal is assembled in the terminal slot 11. Thus, when the CPU is connected to the terminal, the pin of the CPU can be inserted into the wide region 12 with zero force, and then slide into the narrow region 13 to be electrically connected to the contact sheet 19.

Although the conventional terminal structure is very simple and easy to be manufactured by way of pressing, the terminal only contacts the pin at a single surface, and the electrical connection effect is not very good.

FIG. 2 is a pictorial view showing a terminal of the conventional ZIF electrical connector, which is disclosed in Taiwan Patent Publication No. 271866. The ZIF electrical connector of FIG. 2 includes an inverse U-shaped main body 21 and a pin 22 connected to a bottom of the main body. The main body 21 is also formed with an inverse U-shaped open slot 23 such that the main body 21 can be elastically opened toward two sides. The open slot 23 is formed with a narrow slot 24. When the CPU is connected to the terminal, the pin of the CPU may be inserted into the front of the narrow slot 24, and then slide into the narrow slot 24 to be electrically connected to the main body 21.

When the pin of the CPU slides into the narrow slot 24 to be electrically connected to the main body 21, the pin of the CPU is clamped by two surfaces, through which the electrical connection is made. However, the connection portions are in the narrow slot 24, which is an open plate slot, and the contact surface areas of the cut surfaces are small because the plate thickness of the main body 21 is small. Thus, the electrical connection effect is not good, and the cut surfaces are rougher and may thus scratch the gold-plated layer of the pin of the CPU.

### SUMMARY OF THE INVENTION

It is therefore an object of the invention to provide a terminal structure of a ZIF electrical connector so as to achieve good electrically connection effects with a simple structure manufactured by simple manufacturing processes.

To achieve the above-mentioned object, the invention provides a terminal structure of a ZIF (Zero Insertion Force) electrical connector. The terminal structure includes a U-shaped main body, two first plates and two second plates. The U-shaped main body has two side plate surfaces facing each other with a gap formed therebetween. The first plates are disposed at a top front section of the U-shaped main body and face each other with a first gap formed therebetween. The second plates are disposed at a top rear section of the U-shaped main body and face each other with a second gap formed therebetween, and the second gap is smaller than the first gap.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a pictorially exploded view showing a conventional ZIF electrical connector.

FIG. 2 is a pictorial view showing a terminal of the conventional ZIF electrical connector.

FIG. 3 is a pictorially exploded view showing a ZIF electrical connector according to a first embodiment of the invention.

FIG. 4 is a schematic top view showing one usage state according to the first embodiment of the invention.

FIG. 5 is a schematic top view showing another usage state according to the first embodiment of the invention.

FIG. 6 is a pictorial view showing the terminals and the material tape according to the first embodiment of the invention.

FIG. 7 is a pictorial view showing a ZIF electrical connector according to a second embodiment of the invention.

FIG. 8 is a pictorial view showing a ZIF electrical connector according to a third embodiment of the invention.

FIG. 9 is a pictorial view showing a ZIF electrical connector according to a fourth embodiment of the invention.

FIG. 10 shows a usage state of the ZIF electrical connector according to the fourth embodiment of the invention.

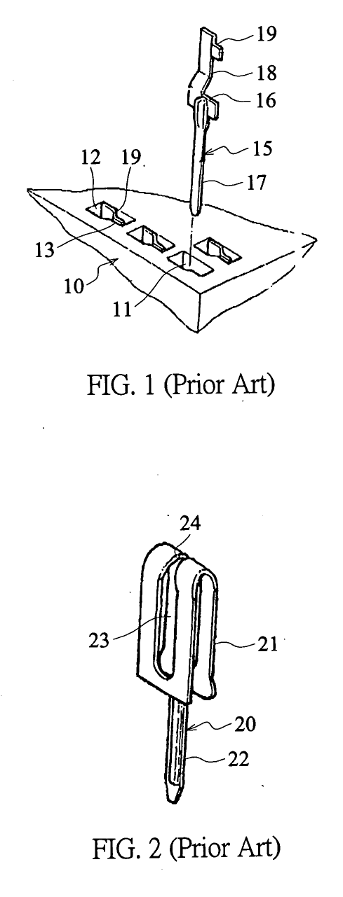

### DETAILED DESCRIPTION OF THE INVENTION

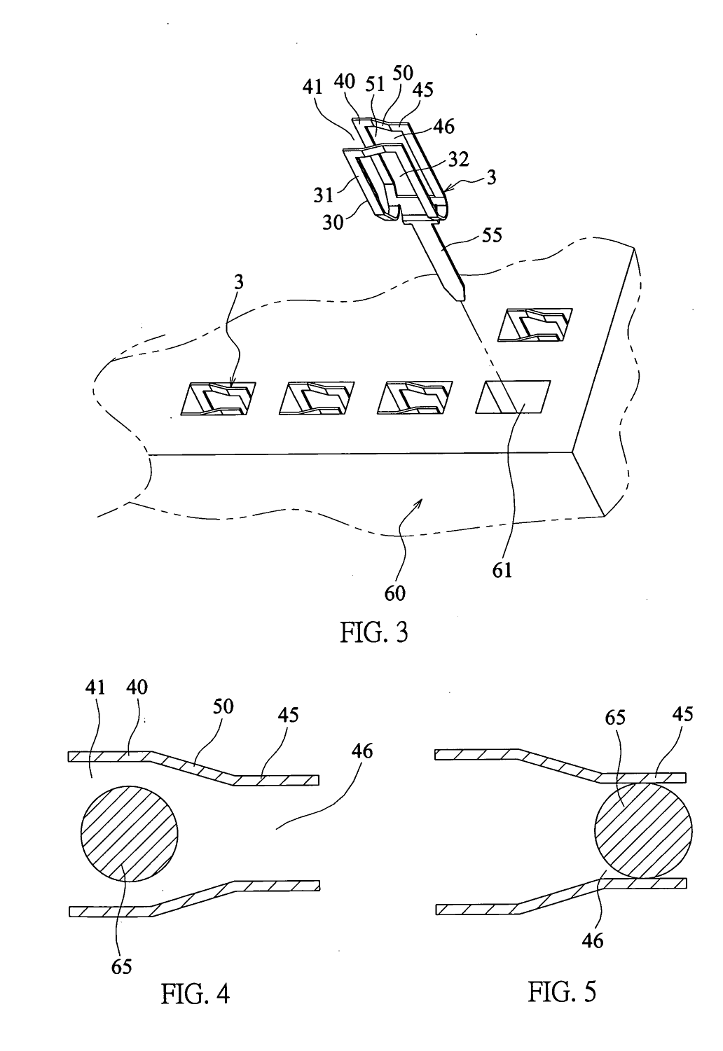

Referring to FIG. 3, a ZIF (Zero Insertion Force) electrical connector of this embodiment includes a plastic base 60 and a plurality of terminals 3. The plastic base 60 is formed with a plurality of terminal slots 61. The terminal 3 is integrally formed with a U-shaped main body 30, two first plates 40, two second plates 45, two third plates 50 and one pin 55.

The U-shaped main body 30 has two side plate surfaces 31 facing each other with a gap formed therebetween. Each side plate surface 31 is formed with an opening 32 and thus has a frame shape such that the U-shaped main body 30 has good elasticity.

The two first plates 40 are disposed at a top front section of the U-shaped main body 30, and the two first plates 40 face each other with a first gap 41 formed therebetween.

The two second plates 45 are disposed at a top rear section of the U-shaped main body 30, and the two second plates 45 face each other with a second gap 46 formed therebetween, wherein the second gap 46 is smaller than the first gap 41.

The two third plates 50 are disposed at a top of the U-shaped main body 30 and between the first plates 40 and the second plates 45. The third plates 50 face each other with a third gap 51 formed therebetween, wherein the third gap 51 shrinks from the first gap 41 to the second gap 46.

The pin 55, which longitudinally extends downwards, is formed by pressing and jabbing into one of the side plate surfaces 31 of the U-shaped main body, and the side plate surface 31 is formed with the opening.

According to the above-mentioned structure, when the terminal 3 is assembled into the terminal slot 61 of the plastic base 60, the terminal 3 can be tightly fixed according to the elasticity of the main body 30. As shown in FIG. 4, the pin 65 of the CPU is firstly inserted into the first gap 41. Then, as shown in FIG. 5, when the CPU is moved, its pin 65 slides into the second gap 46 and is clamped by the second plates 45 with the plate elasticity.

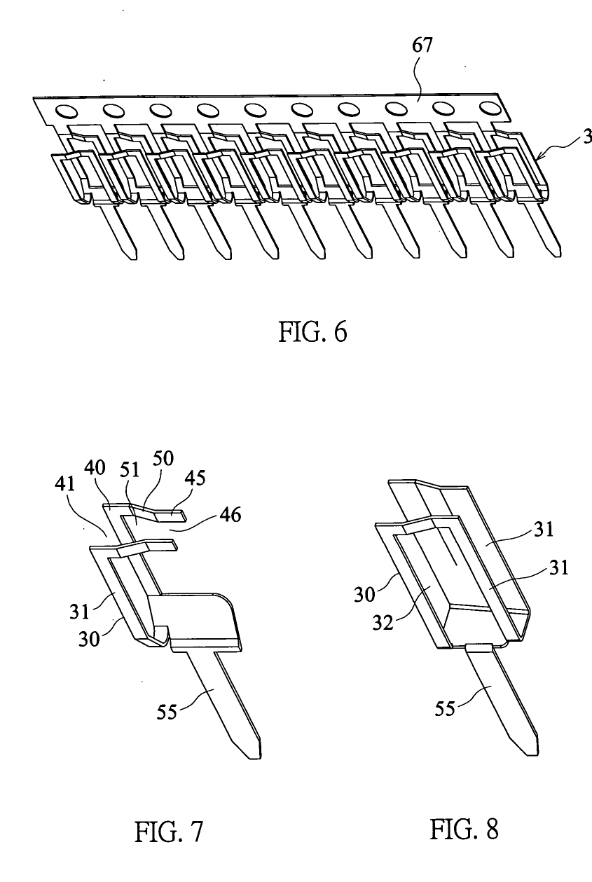

FIG. 6 is a pictorial view showing the terminals 3 and the material tape 67 according to the first embodiment of the invention. The structure of the invention is very simple. Each terminal is formed by bending a U-shaped plate, and the pin is formed by pressing and jabbing into the side plate surface 31 of the U-shaped main body 30. Thus, the terminals 3 may be easily manufactured with reduced material. In addition, the terminals 3 may be arranged on and connected to the material tape 67 according to the gaps between the terminal slots 61, so a row of terminals 3 may be assembled into the terminal slots 61 of the plastic base at the same time.

The terminal structure of the invention has the following advantages.
1. The structure is simplified and is easily to be manufactured with reduced material.
2. The terminals 3 may be arranged on and connected to the material tape 67 according to the gaps between the terminal slots 61, so a row of terminals 3 may be assembled into the terminal slots 61 of the plastic base at the same time.
3. The pin 65 of the CPU is clamped between the elastic second plates 45, so the electrical connection effect is good. In addition, the plate is smooth and is free from scratching the gold-plated layer of the pin of the CPU.

As shown in FIG. 7, the second embodiment is almost the same as the first embodiment. Similarly, the terminal of the second embodiment also has a U-shaped main body 30, two first plates 40, a first gap 41, two second plates 45, a second gap 46, two third plates 50, a third gap 51 and a pin 55. The difference between the first and second embodiments resides only in that most of the two side plate surfaces 31 of the U-shaped main body 30 of the second embodiment is removed and only a small plate is left. Thus, only the two first plates 40 are connected to a top of the side plate surface 31, and the two second plates 45 are not connected to the side plate surface 31. Consequently, the two second plates 45 may have higher elasticity and may be easily moved in an elastic manner.

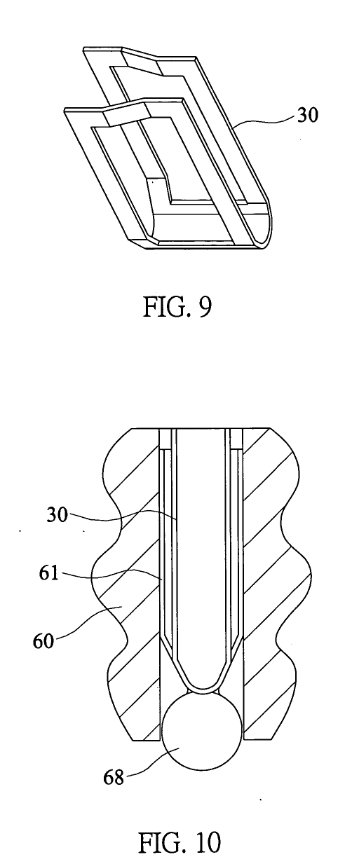

As shown in FIG. 8, the terminal of the third embodiment is almost the same as that of the first embodiment. The main difference between the third and first embodiments resides only in that only one side plate surface 31 of the U-shaped main body 30 has the opening 32, and a pin 55 longitudinally extending downwards is formed by pressing and jabbing into the side plate surface 31.

As shown in FIG. 9, the terminal of the fourth embodiment is almost the same as that of the first embodiment. The main difference between the fourth and first embodiments resides only in that no longitudinally extending pin is connected to the U-shaped main body 30 in the fourth embodiment. As shown in FIG. 10, after the terminal is assembled into the terminal slot 61 of the plastic base 60, a solder ball 68 is mounted to the bottom of the terminal slot 61 and electrically connected to the U-shaped main body 30. Thus, a solder ball type connection point is formed.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A terminal structure of a ZIF (Zero Insertion Force) electrical connector, comprising:
a U-shaped main body having two side plate surfaces facing each other with a gap formed therebetween;
two first plates disposed at a top front section of the U-shaped main body, wherein the two first plates face each other with a first gap formed therebetween; and
two second plates disposed at a top rear section of the U-shaped main body, wherein the two second plates face each other with a second gap formed therebetween, and the second gap is smaller than the first gap.

2. The terminal structure according to claim 1, wherein each of the two side plate surfaces of the U-shaped main body has an opening.

3. The terminal structure according to claim 1, further comprising a pin, which longitudinally extends downwards and is formed by pressing and jabbing into one of the side plate surfaces of the U-shaped main body, wherein the side plate surface is formed with an opening.

4. The terminal structure according to claim 1, further comprising two third plates disposed on a top of the U-shaped main body and between the two first plates and the two second plates, wherein the two third plates face each other with a third gap formed therebetween, and the third gap gradually shrinks from the first gap to the second gap.

5. The terminal structure according to claim 1, further comprising a solder ball connected to a bottom of the U-shaped main body, wherein the solder ball serves as a connection point.
